(19) United States
(12) Patent Application Publication
(10) Pub. No.: US 2012/0177021 A1
(43) Pub. Date: Jul. 12, 2012

(54) Communication and Information Systems and Methods

(75) Inventor: Allen A. Shipman, Austin, TX (US)

(73) Assignee: TEXAS ENERGY NETWORK, LLC, Houston, TX (US)

(21) Appl. No.: 13/343,043

(22) Filed: Jan. 4, 2012

Related U.S. Application Data
(60) Provisional application No. 61/429,710, filed on Jan. 4, 2011.

(51) Int. Cl. H04W 88/16; H04W 84/12

(52) U.S. Cl. 370/338

(57) ABSTRACT

A system, method, and device provide a remote communications platform. In one embodiment, an information and communication transmission system includes a communication device and a router. The router is connected to the communication device. In addition, the router is able to communicate with a WiFi capable device and/or an Ethernet capable device. The communication device communicates with a transmission receiver. The information and communication transmission system also includes a power supply. The power supply provides power to the communication device and the router.

### CROSS-REFERENCE TO RELATED APPLICATIONS

This application is a non-provisional application that claims the benefit of U.S. Application Ser. No. 61/429,710 filed on Jan. 4, 2011, which is incorporated by reference herein in its entirety.

### STATEMENT REGARDING FEDERALLY SPONSORED RESEARCH OR DEVELOPMENT

Not applicable.

### BACKGROUND OF THE INVENTION

1. Field of the Invention

This invention relates to the field of communications and more specifically to the field of remote, stand-alone communications and data transmissions systems.

2. Background of the Invention

A variety of communications systems have been used in the energy communications industry. Typically, the communications systems have used different network solutions. Drawbacks to conventional systems include transmitting and receiving data and communications in remote locations. Further drawbacks include inefficient consolidation of data and commercial transmission means.

Consequently, there is a need for improved methods of communication in the energy industry.

### BRIEF SUMMARY OF SOME OF THE PREFERRED EMBODIMENTS

These and other needs in the art are addressed in one embodiment by an information and communication transmission system. The information and communication transmission system includes a communication device and a router. The router is connected to the communication device. The router is able to communicate with a WiFi capable device and/or an Ethernet capable device. The communication device communicates with a transmission receiver. The information and communication transmission system also includes a power supply. The power supply provides power to the communication device and the router.

These and other needs in the art are addressed in another embodiment by an information and communication device. The information and communication device includes a support stand and a communication device. The information and communication device also includes a router. The router is connected to the communication device. In addition, the router is able to communicate with a WiFi capable device and/or an Ethernet capable device. The communication device communicates with a transmission receiver. The information and communication device further includes a communications equipment container. The communication device and the router are disposed in an interior of the communications equipment container. The communications equipment container is secured to the support stand. Moreover, the information and communication device includes a power supply. The power supply provides power to the communication device and the router.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a schematic of an embodiment of an information and communication transmission system having a communication device and a router;

FIG. 2 illustrates a schematic of an embodiment of an information and communication transmission system including a communications equipment container;

FIG. 3 illustrates a schematic of an embodiment of an information and communication transmission system including a serial converter;

FIG. 4 illustrates an embodiment of a communications equipment container in an open position with contained devices shown outside of the container for illustrative purposes;

FIG. 5 illustrates a schematic of an embodiment of a power supply; and

FIG. 6 illustrates a side perspective view of an embodiment of an information and communications device.

### DETAILED DESCRIPTION OF THE PREFERRED EMBODIMENTS

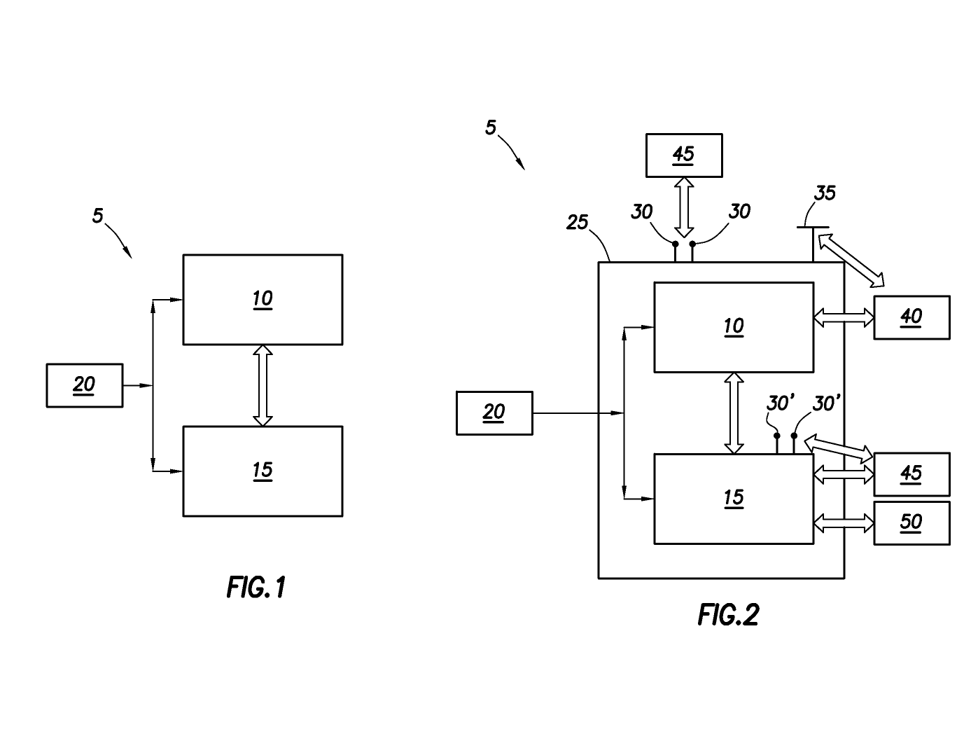

FIG. 1 illustrates an embodiment of information and communication transmission system 5. In the embodiment as shown, information and communication transmission system 5 includes communication device 10, router 15, and power supply 20. Without limitation, information and communication transmission system 5 provides a portable system for providing communications services such as voice over the Internet (VoIP) calling, Ethernet LAN, WiFi access point, facsimile, scan, data storage and forwarding, secure virtual private network (VPN) services, Internet access, SCADA, RS-232, RS485, or any combinations thereof. Further, without limitation, such communications services may be provided in any desired area, including remote areas lacking in wireline, cellular and/or power (i.e., electricity) sources.

Embodiments of communication device 10 include a radio and/or an Ethernet switch. Any radio suitable for transmission of information, voice, video, and data may be used. In embodiments, the radio is suitable for transmissions with a cellular tower (not illustrated). In some embodiments, the radio is an AWS LTE radio. In some embodiments, communication device 10 comprises a dongle. In an embodiment, the radio has between about 1,710 Mhz and about 1,755 Mhz, alternatively between about 2,110 Mhz and about 2,155 Mhz, and alternatively between about 698 Mhz and about 806 Mhz. The Ethernet switch may include one or more Ethernet ports. Any Ethernet switch suitable for transmission of information, voice, video, and data operating between about 10 Mbps and about 1 Gbps may be used. In some embodiments, communication device 10 is hardened. Hardened refers to electronic components manufactured and packaged in a manner that enables direct exposure to an outdoor environment without the need for separate heating and cooling systems, or separate housing or shelter to protect them from the natural elements of wind, rain, snow, sleet, hail, direct sun exposure, hose directed water, splashing water, and damage from external ice formation. This may include devices rated NEMA Standards Publication number 250, type 4 or higher or IEC Ingress Protection Standard 60529 designation IP56 or higher. In embodiments, hardened components may operate at temperatures in excess of 100° F. and at temperatures below 32° F.

In embodiments, router 15 may include any router suitable for receiving and forwarding information, voice, video, and data. In an embodiment, router 15 is a cellular router or router capable of interfacing with a wireless backhaul network. Embodiments include router 15 able to communicate with a WiFi capable device and/or an Ethernet capable device. In embodiments, information, voice, video, data, or any combinations thereof are transmitted from WiFi and/or Ethernet devices to router 15. Router 15 forwards the information, voice, video, data, or any combinations thereof to communication device 10. In an embodiment, communication device 10 is connected to router 15. Communication device 10 may be connected to router 15 by any suitable means. In an embodiment, communication device 10 is connected to router 15 by a direct electrical connection. In other embodiments, communication device 10 is connected to router 15 by an indirect electrical connection. In embodiments, an indirect electrical connection may include a connection via any other suitable devices and connections.

Power supply 20 may include any suitable sources of providing power (i.e., to communication device 10 and router 15). In an embodiment, power supply 20 includes battery power, commercial power, solar power, or any combinations thereof. Without limitation, power supply 20 including battery power, solar power, or any combinations thereof may allow information and communication transmission system 5 to have an autonomous function (i.e., not dependent upon commercial power). FIG. 5 illustrates a schematic of an alternative embodiment of information and communication transmission system 5 in which power supply 20 has solar power 80, battery power 85, and commercial power 90. Solar power 80 may include any device suitable for capturing solar energy and providing such energy as electrical power. In embodiments, solar power 80 comprises one or more solar panels. In embodiments as shown, solar power 80 may provide power to the components of information and communication transmission system 5 (i.e., communication device 10, router 15, and the like). In some embodiments, solar power 80 may provide power to the components of information and communication transmission system 5 and/or provide power to battery power 85 (i.e., to re-charge battery power 85). In embodiments, solar power 80 provides power to battery power 85. Battery power 85 may include any type of battery suitable for use in a field environment. In embodiments, battery power 85 includes a re-chargeable battery or batteries. In an embodiment, battery power 85 includes one or more batteries that may be re-charged a plurality of times. In embodiments as shown, rectifier charge controller 75 directs power from solar power 80 to the components of information and communication transmission system 5 and/or battery power 85. Rectifier charge controller 75 may include any type of rectifier charge controller suitable for providing rectification to power. In an embodiment rectifier charge controller 75 is a rectifier charge controller capable of converting an AC (Alternating Current) input with potential between about 110 volts and about 240 volts to DC (Direct Current) output with potential between about 12 volts and about 54 volts. In an embodiment, rectifier charge controller 75 controls the amount of power supplied to battery power 85 (i.e., to re-charge a battery). In an embodiment, rectifier charge controller 75 controls the amount of power supplied to battery power 85 when a battery has a desired percentage of charge. In embodiments, rectifier charge controller 75 reduces the power supplied to battery power 85 when a battery is about 85% or more charged, alternatively stops or reduces the power supplied to battery power 85 when a battery is about 100% charged. In embodiments, rectifier charge controller 75 controls whether power from solar power 80 or from battery power 85 are provided to the components of information and communication transmission system 5. In other embodiments, rectifier charge controller 75 controls the amount of power from solar power 80 and from battery power 85 provided to the components of information and communication transmission system 5. Commercial power 90 may be any type of commercial power source. In such alternative embodiments, commercial power 90 may provide power to battery power 85 (i.e., to re-charge a battery) and/or to the components of information and communication transmission system 5. In alternative embodiments, as shown, the power from commercial power 90 may be controlled by rectifier charge controller 75. In some alternative embodiments, solar power 80 includes a second solar panel (e.g., a redundant, back-up solar panel) and/or battery power 85 includes a second battery (e.g., a redundant, back-up battery).

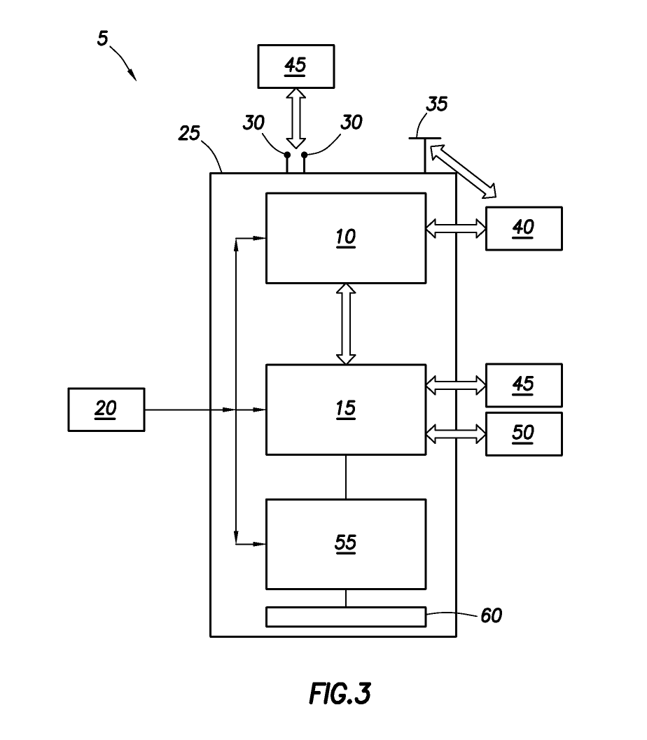

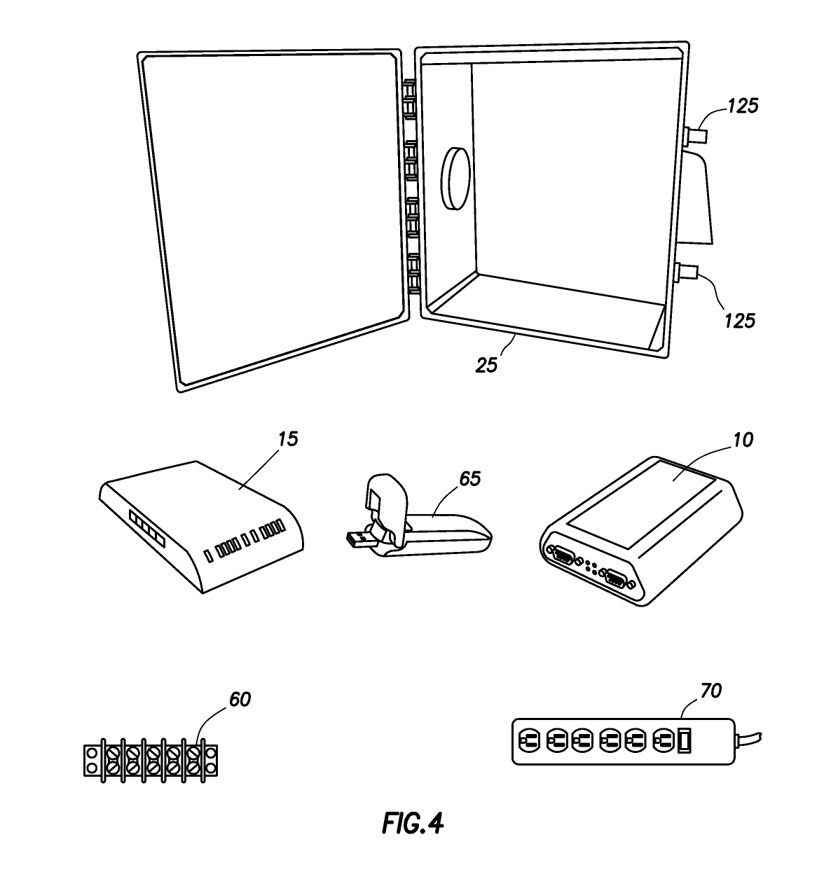

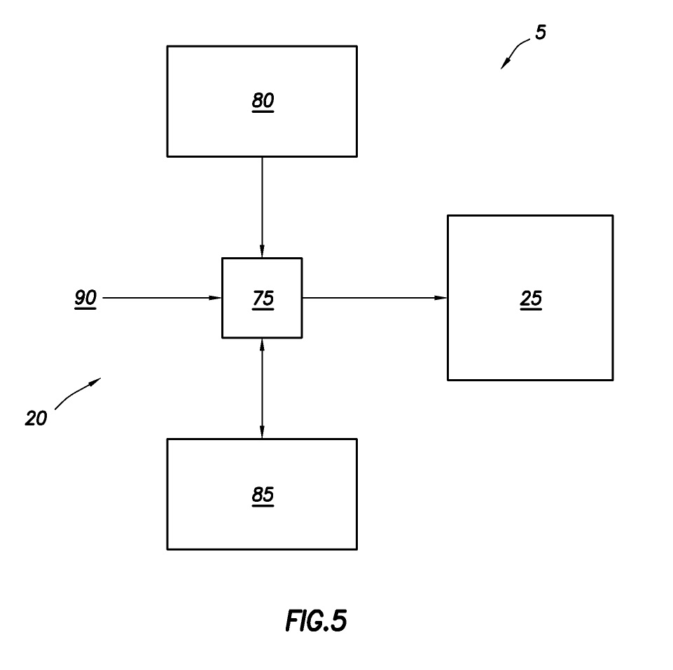

FIG. 2 illustrates an embodiment of information and communication transmission system 5 having communications equipment container 25. In embodiments as shown, communication device 10 and router 15 are disposed within communications equipment container 25. In other embodiments (not shown), communication device 10 and/or router 15 are disposed outside of communications equipment container 25. Communications equipment container 25 is an enclosure with an interior in which the components of information and communication transmission system 5 (i.e., communication device 10, router 15, and the like) are disposed. In an embodiment, communications equipment container 25 is openable and closeable. FIG. 4 illustrates an embodiment of communications equipment container 25 in which communications equipment container 25 has a hinged door that is openable and closeable. As shown in FIG. 4, communications equipment container 25 has securing means 125. Securing means 125 includes any suitable means for securing the closure of communications equipment container 25 such as clasps. For illustrative purposes only, the FIG. 4 illustration of an embodiment of the components of information and communication transmission system 5 show such components disposed outside of communications equipment container 25. Communications equipment container 25 may be composed of any non-pliable material such as plastic, metal, ceramic, and the like.

In an embodiment as shown in FIG. 2, power supply 20 provides power to communication device 10 and router 15. In an embodiment as shown, router 15 may be in communication with WiFi capable devices 45 and/or Ethernet capable devices 50. WiFi capable devices 45 and/or Ethernet capable devices 50 may be connected to router 15 or may be wirelessly communicating with router 15. WiFi capable devices 45 include one or more WiFi devices. In an embodiment, WiFi capable devices 45 include a computer, phone, facsimile machine, scanner, camera, video camera, alarm, or any combinations thereof. Ethernet capable devices 50 include one or more devices capable of communication via Ethernet. In an embodiment, Ethernet capable devices 50 include a computer, phone, facsimile machine, scanner, camera, video camera, alarm, or any combinations thereof. Embodiments include Ethernet capable device 50 comprising a RJ45 capable device. In embodiments as shown, router 15 includes router antenna 30 for communicating with WiFi capable devices 45 and/or Ethernet capable devices 50. In an embodiment as shown, router antenna 30 is disposed outside of communications equipment container 25 and on the top side of communications equipment container 25. In embodiments as shown, router 15 has two router antenna 30. However, it is to be understood that router 15 is not limited to two router antenna 30, but in alternative embodiments router 15 may have one router antenna 30 or more than two router antenna 30. In an alternative embodiment as shown, router 15 also has router antenna 30′ disposed in the interior of communications equipment container 25. Router antenna 30, 30′ may include any type of antenna suitable for communicating with WiFi capable devices 45. In an embodiment, router antenna 30, 30′ comprise an omni-directional antenna. The facsimile devices, scanners, and phones may be any facsimile devices, scanners, and phones capable of WiFi and/or Ethernet such as VoIP facsimile devices, VoIP scanners, VoIP phones, cell phones, and the like. In an embodiment, the facsimile devices and/or phones each have a dedicated telephone number. For instance, an outside caller may dial the dedicated number for one of such phones and therefore may reach a phone (i.e., WiFi capable device 45 and/or Ethernet capable device 50) via router 15.

In embodiments as shown in FIG. 2, communication device 10 may be in communication with transmission receiver 40. Transmission receiver 40 may be one or more than one transmission receivers 40 and may be proximate or remote from communication device 10. Transmission receiver 40 may be any receiver capable of communicating (e.g., receiving a transmission and forward a transmission) with communication device 10. In an embodiment, transmission receiver 40 is a cellular tower. In an embodiment as shown, communication device 10 has communication device antenna 35 for communicating with transmission receiver 40. In an embodiment, communication device antenna 35 is disposed outside of communications equipment container 25. In embodiments as shown, communication device 10 has one communication device antenna 35. However, it is to be understood that communication device 10 is not limited to one communication device antenna 35, but in alternative embodiments communication device 10 may have more than one communication device antenna 35. Communication device antenna 35 may include any type of antenna suitable for communicating with transmission receiver 40. In an embodiment, communication device antenna 35 comprises a fixed, directional antenna. In some embodiments, communication device antenna 35 is a yagi antenna.

FIG. 3 illustrates an embodiment of information and communication transmission system 5 further including serial converter 55 and serial terminal 60. Serial converter 55 is connected to router 15. Serial terminal 60 has a serial communication physical interface and is connected to serial converter 55. In embodiments, serial devices are connected to serial terminal 60, and the communications from the serial devices are converted by serial converter 55 and transmitted to router 15. In some embodiments (not illustrated), serial converter 55 and serial terminal 60 have combined functionality in one device. In embodiments as shown, serial converter 55 and serial terminal 60 are disposed in the interior of communications equipment container 25. In further embodiments as shown, power supply 20 provides power to serial converter 55.

In an embodiment of operation of information and communication transmission system 5 as shown in the embodiments of FIGS. 1-5, power supply 20 provides power to communication device 10, router 15, and serial converter 55. A user may plug a serial device such as a computer into serial terminal 60 and send a communication (i.e., email, alarms, system measurements, and the like) to serial converter 55. Serial converter 55 converts the communication and sends the communication to router 15, through which the communication is sent to communication device 10. From communication device 10, the signal is sent to transmission receiver 40 and to its desired destination. Outside communications (i.e., from a remote computer) may also be sent to transmission receiver 40 and then to communication device 10, which sends the communication to router 15 and thereby on to serial converter 55. Serial converter 55 converts the sign, and via serial terminal 60 the communication is received by the serial device. In other embodiments, a communication from a WiFi capable device 45 and/or an Ethernet capable device 50 is sent to router 15 and then to communication device 10, from which it is sent to transmission receiver 40 and to its desired destination (i.e., a remote computer). Outside communications (i.e., from a remote computer) may also be sent to transmission receiver 40 and then to communication device 10, which sends the communication to router 15 and thereby on to WiFi capable device 45 and/or an Ethernet capable device 50. In embodiments as shown in FIG. 4, information and communication transmission system 5 includes a dongle 65, which when plugged into router 15 activates the software to operate information and communication transmission system 5. Dongle 65 is a communications device with similar functionality to communications device 10. In embodiments, dongle 65 has a USB interface instead of an RF 45 interface, and dongle 65 receives its power from router 15 directly. In an embodiment, dongle 65 may operate independently of communication device 10 or in conjunction with communication device 10. In embodiments, information and communication transmission system 5 has dongle 65, communication device 10, or both. In embodiments as shown in FIG. 4, information and communication transmission system 5 include power strip 70 from which power from power supply 20 is provided to communication device 10, router 15, and/or serial converter 55. In embodiments, power strip 70 is disposed in the interior of communications equipment container 25.

In embodiments, WiFi capable device 45 comprises a video camera (e.g., a WiFi video camera) and/or Ethernet capable device 50 comprises a video camera (e.g., a video camera with an Ethernet jack). The video cameras may record live video and/or sound to view. In embodiments, a remote computer may log into one of the video cameras via information and communication transmission system 5 and access the recording of the video camera, watch the video camera live, and/or control the camera. For instance, a remote camera may (via transmission receiver 40 and then communication device 10) access the video camera (e.g., WiFi capable device 45 and/or Ethernet capable device 50) via router 15.

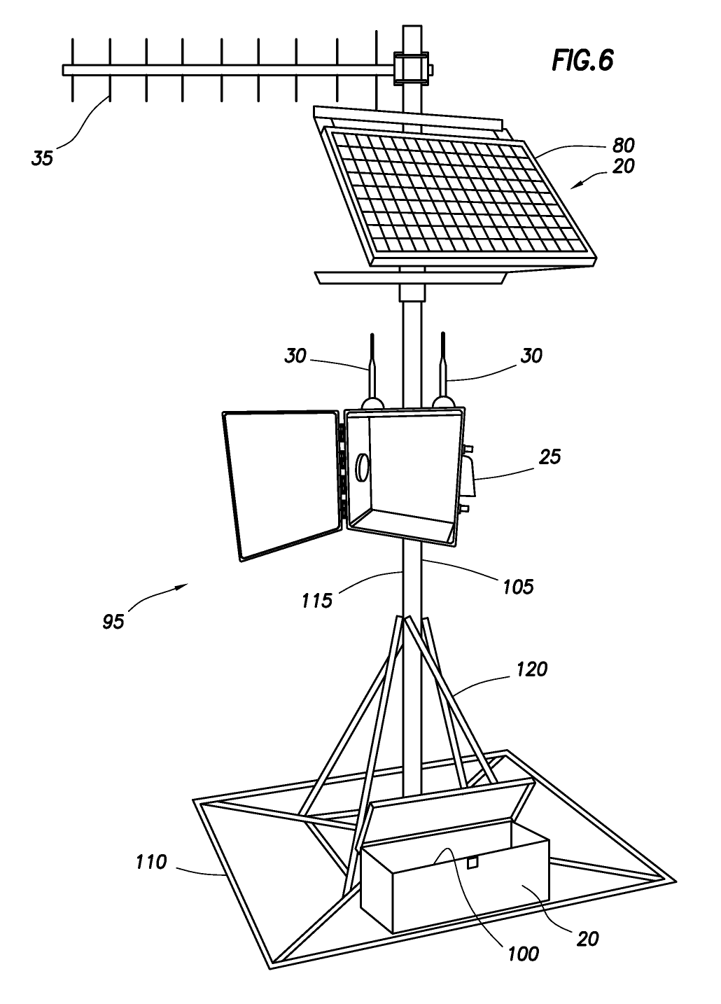

FIG. 6 illustrates an embodiment of information and communication device 95. Information and communication device 95 includes communications equipment container 25, power supply 20, and support stand 105. In embodiments as shown, support stand 105 has base 110, vertical support 115 (i.e., a pole), and vertical stabilizers 120. An end of vertical support 115 is secured to base 110. Vertical stabilizers 120 are secured to both base 110 and vertical support 115. Without limitation, vertical stabilizers 120 reduce or prevent lateral movement of vertical support 115. Communications equipment container 25 is secured to vertical support 115. Communications equipment container 25 is shown in a open position without any of the components of information and communication transmission system 5 (i.e., communication device 10, router 15, and the like) for illustrative purposes only. In the embodiment as shown, router antenna 30 are disposed outside of the interior of communications equipment container 25 and on the top side thereof. In the embodiment as shown, power supply 20 includes a battery container 100. In embodiments (not shown), battery power 85 is disposed within an interior of battery container 100. Battery power 85 is not shown for illustrative purposes only. Battery container 100 may be disposed at any suitable location on support stand 105 such as base 110. In embodiments, battery container 100 is secured to support stand 105. As shown, embodiments of information and communication device 95 also include power supply 20 comprising solar power 80. In embodiments as shown, communications equipment container 25 is disposed on support stand 105 between base 110 and solar power 80. As further shown, embodiments include communication device antenna 35. In embodiments as shown, communication device antenna 35 is disposed on an opposing end of information and communication device 95 from base 110.

Although the present invention and its advantages have been described in detail, it should be understood that various changes, substitutions and alterations may be made herein without departing from the spirit and scope of the invention as defined by the appended claims.

What is claimed is:

1. An information and communication transmission system, comprising:
a communication device;
a router, wherein the router is connected to the communication device, and wherein the router is able to communicate with a WiFi capable device and/or an Ethernet capable device, and further wherein the communication device communicates with a transmission receiver; and
a power supply, wherein the power supply provides power to the communication device and the router.

2. The information and communication transmission system of claim 1, wherein the communication device comprises a radio and/or an Ethernet switch.

3. The information and communication transmission system of claim 1, wherein the communication device transmits information, voice, video, data, or any combination thereof.

4. The information and communication transmission system of claim 1, wherein the router comprises a cellular router.

5. The information and communication transmission system of claim 1, wherein the WiFi capable device and/or the Ethernet capable device transmit information, voice, video, data, or any combinations thereof to the router.

6. The information and communication transmission system of claim 5, wherein the information, voice, video, data, or any combinations thereof are transmitted from the router to the communication device.

7. The information and communication transmission system of claim 1, wherein the transmission receiver comprises a cellular tower.

8. The information and communication transmission system of claim 1, wherein the power supply comprises a battery power, a solar power, or any combinations thereof.

9. The information and communication transmission system of claim 8, wherein the solar power provides power to the communication device, the router, the battery power, or any combination thereof.

10. The information and communication transmission system of claim 1, wherein the power supply comprises a rectifier charge controller.

11. The information and communication transmission system of claim 1, further comprising a communications equipment container.

12. The information and communication transmission system of claim 11, wherein the communication device and the router are disposed in an interior of the communications equipment container.

13. The information and communication transmission system of claim 1, wherein the router comprises a router antenna.

14. The information and communication transmission system of claim 1, wherein the communication device comprises a communication device antenna.

15. The information and communication transmission system of claim 1, further comprising a serial converter.

16. The information and communication transmission system of claim 15, wherein the serial converter is connected to the router.

17. The information and communication transmission system of claim 15, further comprising a serial terminal connected to the serial converter.

18. The information and communication transmission system of claim 15, wherein the power supply provides power to the serial converter.

19. An information and communication device, comprising:
a support stand;
a communication device;
a router, wherein the router is connected to the communication device, and wherein the router is able to communicate with a WiFi capable device and/or an Ethernet capable device, and further wherein the communication device communicates with a transmission receiver;
a communications equipment container, wherein the communication device and the router are disposed in an interior of the communications equipment container, and wherein the communications equipment container is secured to the support stand; and
a power supply, wherein the power supply provides power to the communication device and the router.

20. The information and communication device of claim 19, wherein the power supply comprises a solar power and a battery power, and wherein the solar power is secured to the support stand.
